(19) United States
(12) Patent Application Publication
(10) Pub. No.: US 2015/0213352 A1
(43) Pub. Date: Jul. 30, 2015

(54) ARTIFICIAL FINGERNAIL OR TOE NAIL WITH AN INCORPORATED TRANSPONDER

(71) Applicant: YVES SWISS AG, Sursee (CH)

(72) Inventor: Claud Niedermann, Oberkirch (CH)

(21) Appl. No.: 14/425,125

(22) PCT Filed: Aug. 22, 2013
(86) PCT No.: PCT/CH2013/000150

§ 371 Date: Mar. 2, 2015

(30) Foreign Application Priority Data
Aug. 28, 2012 (CH) 01494/12

(51) Int. Cl. G06K 19/077; A45D 31/00

(52) U.S. Cl. CPC G06K 19/0776; A45D 31/00; G06K 19/07745

(57) ABSTRACT

An artificial nail for placing onto a finger or a toe is connected to an integrated transponder chip (2), which is preferably placed on the underside of the artificial nail. The integrated transponder chip measures only a few millimeters in diameter and is ultra-thin. The artificial nail is placed onto the natural nail using a nail treatment system. The integrated transponder chip is designed for a near-field application and is intended to be active in a range of a few centimeters. Electromagnetic radiation activates the chip and the detected signals identify the latter. The person wearing such an artificial nail need only hold the artificial nail in the vicinity of a detector of the integrated transponder chip and the person is able to be identified for any desired application.

The invention relates to an artificial nail into which a transponder chip is inserted and that is usable on a natural finger nail or a toe nail. A connection to the software application can be made by identifying the transponder.

Several different kinds of artificial nails for putting on a natural finger nail or toe nail do exist. The artificial nails which are used by nail designers in the USA get more and more supporters, be it as prolongation or enhancement of the natural nail. Nowadays, several nail handling systems are offered, as for example fixing with gel, acrylic or via wrapping technique, as well as different combinations and variations thereof. Modeling of the nails requires special nail tips. A nail tip is a nail top out of synthetic material or other materials which are fixed on the natural nail by using glue. This sort of prolongation of nails is equated with the formerly used method of pattern technique that was used by nail designers. Nail tips are available in various forms and sizes and also including stop points defining how far they shall be pushed over the natural nail. The nail designer can have them in the very plain version as well as in a strongly bent embodiment. If possible, the nail tip shall coincide with the form of the natural growing nail. In order to make the wearing of the artificial nail less uncomfortable, that one is chosen by the nail designer with major care, this is also valid for the pattern technique. First, the natural nail is brought into a shape that makes the nail tip into conformity with the indentation on the underside.

In order to make the nail tip appearing more natural, it is rasped until the switchover to the natural nail becomes transparent. As far as possible, the nail should not be rasped by the female or male nail designer. According to nail growth, the artificial nails must be refilled in intervals of every 2 to 5 weeks. Whilst this is done, the form is shortened again at the point of the nail and on the section behind of the nail this one is filed with an artificial material. The modellage procedure of artificial nails on acrylic basis applied by nail designers is gentle to the nail. Acrylic is a synthetic material that is flexible and resilient. When this procedure is used, the nail designer (female or male) will first shorten and rasp the nails and then the designer will matt them. The artificial nail tips will then be fixed and rasped in the matching form by the nail designer. Subsequently, the layers will be built and hardened under a lamp (UVB/CCFL/LED etc.). The shape of an artificial nail can be depending on the shape of the natural nail. The nail designer will look to it that the shape of the modeling on both hands or on both feet and respectively on all fingers or respectively toes will receive the same proportions. Basis and form line should stay in the same angle toward each other on each finger/toe.

The artificial nails which are fixed by the nail designers can also be removed if necessary, this is what makes them especially variable. Therefore, the whole modeling of the artificial nails is untightened with acetone or another menstruum and afterwards separated. However, the nail design of gel nails is not completely removable within 45 minutes. In case of the application of gel varnish instead, this is possible. This gel should be rasped away with care. If it is the dase that after taking the nail off, a new modeling shall take place, it is advisable to make an accurate manicure. Thus, the natural nail recovers faster from strains and is strengthened for a healthy growth. The common products only change the appearance of the carrier. Continuous benefit or function is not included in this artificial nails.

The artificially fixed nails are always present, no matter where or when. They cannot be lost and therefore they are, once they are fixed, unseparable from the carrier, even more than a credit card, a cell phone, earrings, a clock or even a finger ring. Those things can be taken off or lost. The loss of an artificial nail is almost disclosed and if it happened yet then sure not without the carrier realizing this, as it causes pressure and pain if artificial nails are taken off by force, no matter which manipulation is used. Therefore an artificial nail is useful as means of identification. In the easiest case, a bar code could be fixed on the surface of the nail, but such identifications are very restricted in their application and a bar code is destroyable or is worn off by abrasion and then it is no more legible. Furthermore a visible bar code on the finger nail is not everybody's cup of tea for esthetic reasons.

The task of the present invention is therefore to design the artificial nails as a means of identifidation so that this identification means firstly remain visible and secondly stay connected with the carrier and thirdly that this identification means offer the most application possibilities and ultimately it is replaceable as needed.

This task is solved by an artificial nail that is characterized in that at least one chip with transponder function is connected to it.

With the help of the drawings, the invention is presented and its function is explained.

It shows:

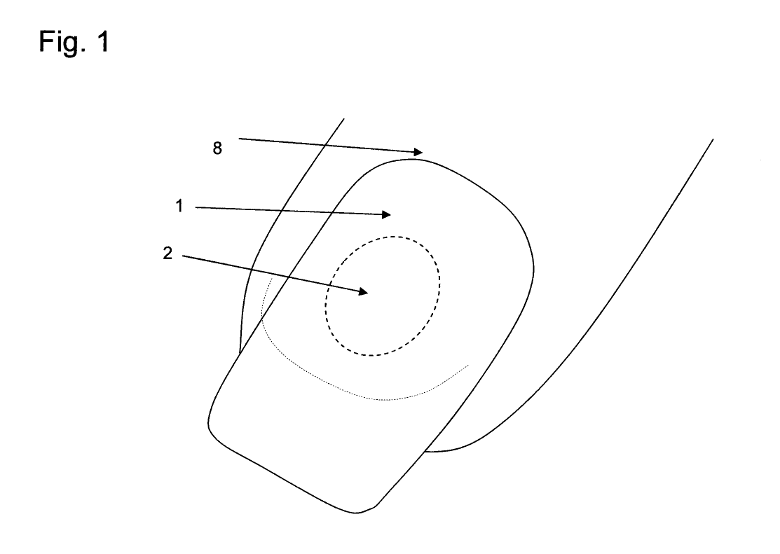

FIG. 1: An artificial nail, fixed on the natural finger nail of a finger or on a toe nail of a food and equipped with an implemented or fixed chip;

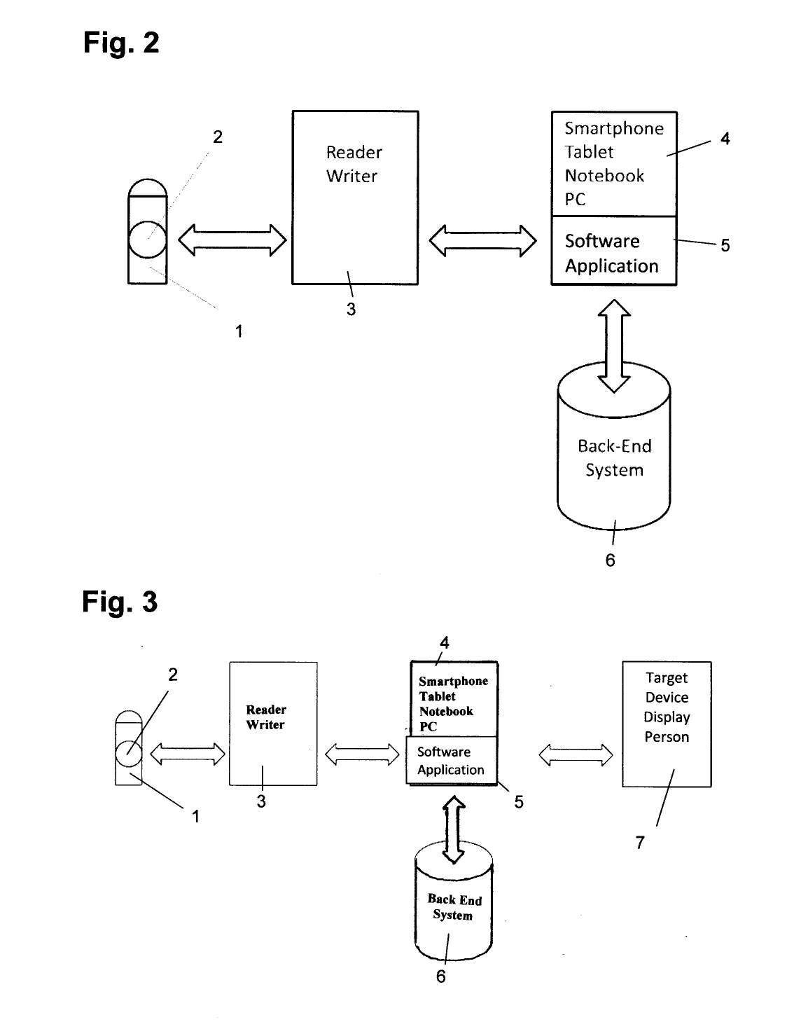

FIG. 2: The functionality of the chip on the artificial nail in schematic representation;

FIG. 3: The operating mode of the chip on or within the artificial nail in connection with a detection system in schematic representation.

There are highly integrated, very compact reading/writing chip sets, reading modules and transponder chips which are conform to the ISO norms 5693 and ISO/IEC 14443. In general, they function with 13.56 MHz because this is a globally available and non licensed radio frequency. The most radio frequency energy is concentrated in the permitted spread of ±7 kHz but whereas the whole bandwidth of the wrapping goes up to 1.8 MHz when amplitude-shift keying (ASK) is used as modulation. The theoretical working distance with compact antenna achieves about 20 cm, whereas the practical working distance is about 4 cm. The data rates are 106. 212 or 424 kbit/s according to ISO/IEC 18092. Such chips are used for the time recording of the staff, for access control, the biometry, the e-payment, parking, ticketing as well as further multiple applications. The transponders can store up to 4096 Bytes and maximum 127 applications can be deposited. Industrial standards like AES, 3DES and DES can be used for the encryption of the communication means. Many benefits are realized by the connection of such a transponder chip with an artificial nail.

FIG. 1 shows an artificial nail 1 on a finger or toe 8 with integrated transponder chip 2 inside the artificial nail 1. There the chip 2 is well placed and assigned to the carrier (female or male) until the artificial nail is replaced. As a rule the artificial nails are worn over months until they are pushed so far forward facing by the growth of the natural nails that they have to be replaced. The chip 2 is preferably incorporated or implemented on the bottom side of the artificial nail 1. It only measures a few mm diameter and is very thin, like a thin metal sheet. Thus, the chip can be incorporated in due form on the bottom side of an artificial nail 1, or he can be glued or be placed into a cavity. Thereafter, the artificial nail 1 is placed onto the natural nail and hardened in the habitual manner via nail handling system as for example a gel. The chip 2 is laying up on a near field application, thus in the area of a small distance of up to 20 cm active. An electromagnetic radiation activates it and the detected signals identify the carrier. Consequently the carrier (female or male) of such an artificial nail onle needs to hold it near the detector or the reading device and then then the person is identified for whatever application. For actions that are highly relevant to security like for example doing payments or for taking money in cash, the chip identification can be combined with a PIN solution or other security mechanisms which significantly increases the security. In case an artificial nail 1 with chip 2 should be lost, the owner or the female owner can immediately deactivate the function of the previously in a software application registered individual chip 2 via cell phone or also via internet online. When the artificial nail 1 which then contains a new chip 2 is replaced, this one is again activated via cell phone or online with the according software application.

For the production of the artificial nails 1 a transponder chip 2 is incorporated according to the invention. The artificial nail 1 can thus be designed visibly or also in a manner that it is not recognizable for a third person. The same is valid for the chip 2 which is incorporated into the nail 1.

FIG. 2 shows the function of the chip 2 on an artificial nail 1 in schematic presentation. On the transponder chip 2 information ex works are saved, for example an identification number, or it can be described later via corresponding devices. The transponder 2 and the artificial nail 1 form a unity. For the reading and writing of information on the artificial nail 1 respectively his chip 2, commercially available reading or writing devices 3 are used. The saved information (e.g. status, identification number, color, age etc.) are sent to a commercially available reading device like for example a smart phone 4 where it is used in a software application 5.

As shown in FIG. 3, the transponder chip 2 of the artificial nail 2 can work together with a detection device. By means of the connection to a back-end-system 6, the artificial nail 1 and thus its carrier (female or male) is identified and the communication between the software application and a aim system 7 which can include an advert shows the carrier (female or male) or respectively another person particular information or activates an automatic process. Thus, articles can for example in an easy manner be reordered, information about the person, about products, about authorizations or information depending on a position can be retrieved, or direct actions lie for example the opening of a locking can be opened and thus security functions can among other things be realized. The access to information about the nail, as well as the data coherent herewith can take place through entitled person by several devices 4. It is also thinkable to fix two or more chips over or on an artificial nail or also to wear a separate transponder chip for different applications on each finger. So the pointer finger nail can for example be used to open the door of the car, the middle finger nail can be used to open the house door, the one on the ring finger can be used to open the access to the working place and the pinky to start the own personal computer etc. Several other functions and its combinations are thinkable.

A further application is to be seen in the authentification. In its easiest form such an authentification after the challenge-and-response principle in which each participant—namely the NFC capable (NFC=Near Field Communication) chip initiates a challenge, whereafter another participant—the NFC tag—must give a valid response to be authenticated. The use of this challenge-and-response principle for recognizing an entitled or respectively unjustified person is already adapted in pipeline-bound solutions for years. This technique is common for e.g. printer cartridges, medical consumer goods, notebook accus or power supplies. The NFC based and thus wireless challenge-and-response procedure gives the consumer the possibility to check the authenticity of a good via NFC able cell phone or even by using a chip in a nail. The chip 2 in the artificial nail is equipped with an energy store for sending signals for the interrogation of tags. Sending can for example be activated via applying pressure on the nail from above or from the front and thus on the chip. Further, the chip in the nail shows at least one diode showing optical signals. Alternatively or additionally it can also be equipped with a buzzer for the release of acoustic signals. The producer must mark his product on only one hidden place with a SHA-1-based (SHA=Secure Hash Algorithm) NFC-tag. Thereafter, it is possible to verify the authenticity of the good with a NFC reader that is included in the chip of the nail. The most important components of the NFC based authentication scheme are the accidental interrogation, the tag UID (Unique Identification Device) and a secret element. The latter is programmed into the protected store of the tag and is known to the programming interface (API) of the questioning device and its application software. An efficient administration system for access codes is indispensable in order to avoid snapping of the system. Between the chip and the product, an electromagnetical field of low distance is made, triggered via pressure on the chip within the nail. This electromagnetical field activates the tag. The chip reads the UID of the tag. The API chip on the nail generates a random questioning and sends the data to the tag. From a UID, the secret element and the received questioning, the tag calculates a SHA-1-MAC (Message Authentication Code). The questioning device compares thereafter its own MAC with the one that has been calculated from the tag. If both MACs accord, the tag is authenticated and the chip on the nail can for example show green light via an included diode or it can give a buzz signal from an inserted buzzer. If the MACs are not identical, the product will identify it as fake or imitate and a red diode will glow. A powerful hash-based cryptographic technology like SHA-1 is a highly efficient tool against product piracy and cloning in connection with the NFC technology. The consumer can simply scan the product and know within a few seconds if it is genuine or not.

1-10. (canceled)

11. An artificial nail for attachment onto a finger nail or onto a toe nail, comprising:
an artificial nail for a person's finger nail or toe nail; and, an integrated transponder chip attached to said artificial nail.

12. The artificial nail for attachment onto a finger nail or onto a toe nail according claim 11, wherein said integrated transponder chip is laminated with a transponder functionality on a bottom side of said artificial nail.

13. The artificial nail for attachment onto a finger nail or onto a toe nail according to claim 11, wherein said artificial nail includes a plurality of laminate layers and said integrated transponder chip is embedded into said plurality of laminate layers of said artificial nail.

14. The artificial nail for attachment onto a finger nail or onto a toe nail according to claim 11, wherein said artificial nail has a cavity in a bottom side of said artificial nail and said integrated transponder chip is inserted into the cavity of said artificial nail.

15. The artificial nail for attachment onto a finger nail or onto a toe nail according to claim 11, wherein said artificial nail has a cavity with said integrated transponder chip located in the cavity of said artificial nail for placement of said integrated transponder chip on an upper side of said artificial nail and with said integrated transponder chip being covered with a nail handling system.

16. The artificial nail for attachment onto a finger nail or onto a toe nail according to claim 15, wherein said nail handling system includes at least one of a gel, an acryl, a nail wrap and a varnish.

17. The artificial nail for attachment onto a finger nail or onto a toe nail according to claim 11, wherein said artificial nail is transparent with said integrated transponder chip thereby being visible.

18. The artificial nail for attachment onto a finger nail or onto a toe nail according to claim 11, wherein said integrated transponder chip includes at least one diode indicating optical signals.

19. The artificial nail for attachment onto a finger nail or onto a toe nail according to claim 11, wherein said integrated transponder chip includes means for sending acoustic signals.

20. The artificial nail for attachment onto a finger nail or onto a toe nail according to claim 19, wherein said means for sending acoustic signals includes at least one buzzer for said integrated transponder chip.
